(19) United States
(12) Patent Application Publication
(10) Pub. No.: US 2005/0058407 A1
(43) Pub. Date: Mar. 17, 2005

(54) Duplex optical transmission-reception module

(76) Inventor: Richard Huang, Hsi-Chih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/663,716

(22) Filed: Sep. 17, 2003

(51) Int. Cl. G02B 6/36

(52) U.S. Cl. 385/89; 385/88

(57) ABSTRACT

A duplex optical transmission-reception module includes an optical fiber. A light-receiving element which corresponds to the optical fiber for receiving optical energy transmitted through the optical fiber from a distal end and converting the optical energy into electric energy which is output from an output terminal. A light-emitting element connected on the light-receiving element. The light-emitting element is projectively aligned with the end face of the optical fiber. When the light-emitting element is energized to project light beam outward, the light beam is projected right to the end face of the optical fiber and input to the optical fiber. The light beam is transmitted along the optical fiber to the distal end to be received by another receiver to output a signal. The function of duplex transmission can be achieved without mounting any refractive element between the optical fiber, the light-receiving element and the light-emitting element.

### BACKGROUND OF THE INVENTION

1. Field of the Invention

The present invention is related to a duplex optical transmission-reception module, and more particularly to a duplex transmission photoelectric module applicable to middle and low speed transmission. The light-emitting element of the module is directly disposed on the light-receiving element and projectively aligned with the end face of the optical fiber.

2. Description of the Prior Art

U.S. Pat. No. 6,188,495 entitled ♭OPTICAL TRANSMISSION-RECEPTION APPARATUS” discloses a duplex optical transmission-reception apparatus. The duplex optical transmission-reception apparatus includes an optical fiber 11, a light-emitting element 3, a beam splitting film 6 and a light-receiving element 4. A lens 8 is disposed between the optical fiber 11 and the light-receiving element 4. The beam splitting film 6 reflects the light emitted from the light-emitting element 3 to the end face of the optical fiber 11. The light beam emitted from the optical fiber 1 1 is refracted to the light-receiving element 4 and converted into electronic signal which is transmitted out. According to the above structure, the beam splitting film 6 can respectively refract the output and input light beam toward different positions to achieve the object of duplex transmission. However, such arrangement has some shortcomings as follows:

1. The beam splitting film 6 for refracting the light beam is quite sophisticated and expensive. Therefore, the product can hardly widely accepted on market.

2. The light beam must be refracted to a fixed true position.

Therefore, it is necessary to extremely precisely install the respective components in their true positions. This increases difficulty in manufacturing so that the ratio of good products can be hardly enhanced.

### SUMMARY OF THE INVENTION

It is therefore a primary object of the present invention to provide a duplex optical transmission-reception module including: an optical fiber; a light-receiving element which corresponds to the optical fiber for receiving optical energy transmitted through the optical fiber from a distal end and converting the optical energy into electric energy which is output from an output terminal; and a light-emitting element connected on the light-receiving element. The light-emitting element is projectively aligned with the end face of the optical fiber. When the light-emitting element is energized to project light beam outward, the light beam is projected right to the end face of the optical fiber and input to the optical fiber. The light beam is transmitted along the optical fiber to the distal end to be received by another receiver to output a signal. The function of duplex transmission can be achieved without mounting any refractive element between the optical fiber, the light-receiving element and the light-emitting element.

The present invention can be best understood through the following description and accompanying drawings wherein:

### BRIEF DESCRIPTION OF THE DRAWINGS

FIG. 1 is a sectional view showing the structure of the present invention;

FIG. 2 is a view according to FIG. 1, showing the receiving state of the present invention;

FIG. 3 is a view according to FIG. 1, showing the output state of the present invention; and

FIG. 4 is a view according to FIG. 1, showing the duplex transmission-reception of the present invention.

### DETAILED DESCRIPTION OF THE PREFERRED EMBODIMENTS

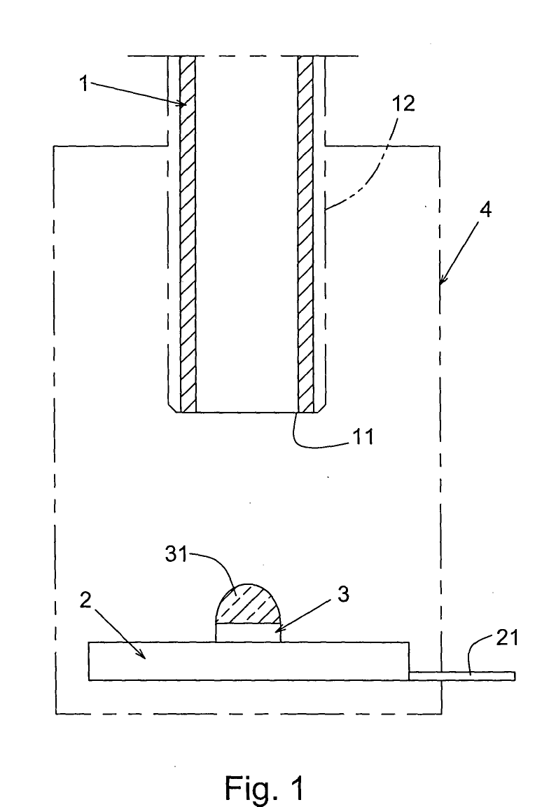

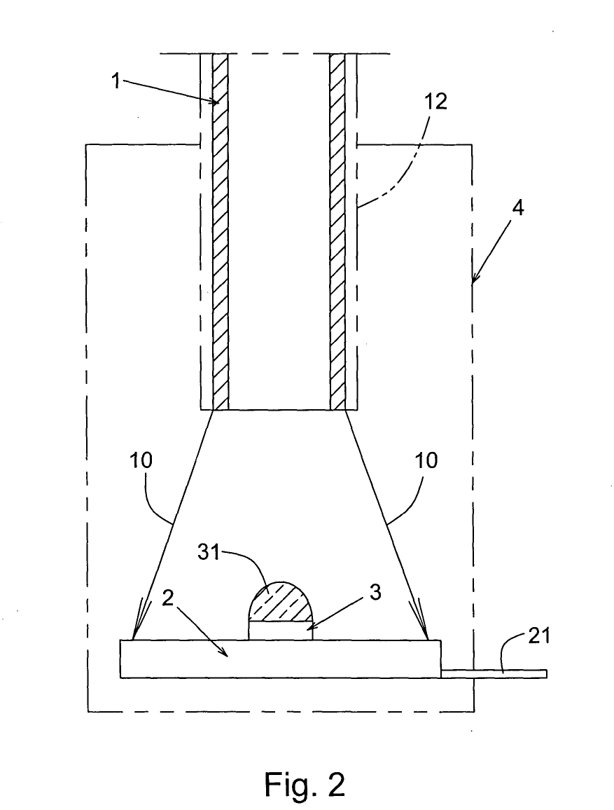

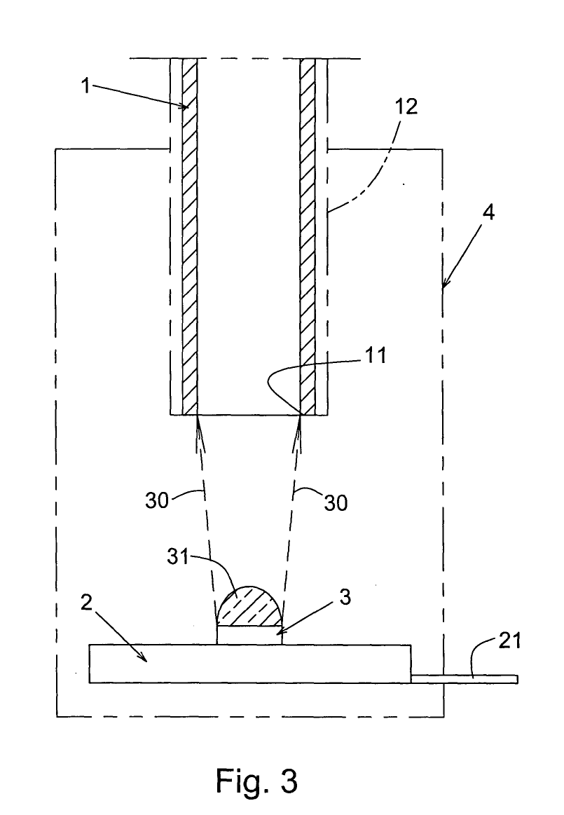

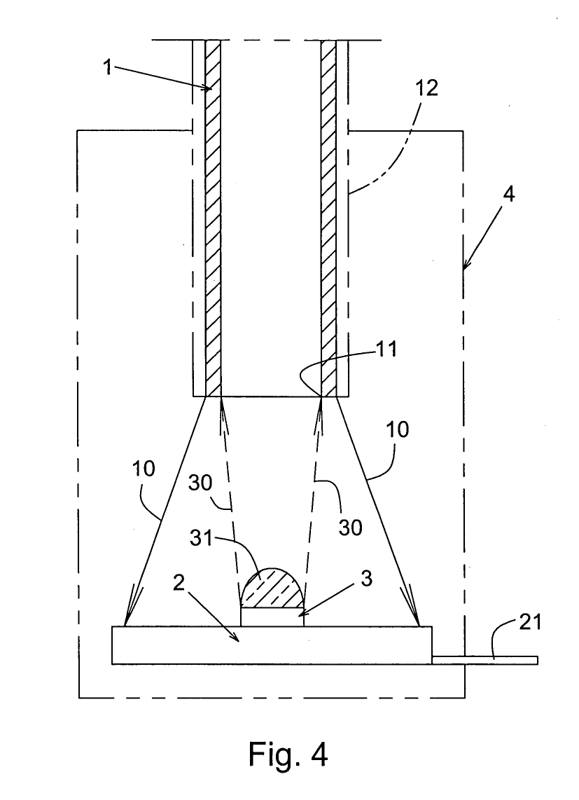

Please refer to FIGS. 1 to 4. The duplex optical transmission-reception module of the present invention includes an optical fiber 1, a light-receiving element 2 and a light-emitting element 3. The light-receiving element 2 corresponds to the optical fiber 1 for receiving optical energy transmitted through the optical fiber 1 from a distal end and converting the optical energy into electric energy which is output from an output terminal 21. The light-emitting element 3 is connected on the light-receiving element 2. The center of the light-emitting element 3 is projectively aligned with the center of the end face 11 of the optical fiber 1. When the light-emitting element 3 is energized to project light beam 30 outward, the light beam 30 is projected right to the end face 11 of the optical fiber 1 and input to the optical fiber 1. The light beam 30 is transmitted along the optical fiber 1 to the distal end to be received by another receiver to output a signal. Accordingly, the function of duplex transmission can be achieved.

In the duplex optical transmission-reception module of the present invention, the light-receiving element 2 is a photodiode. When the photodiode is lighted, the electrons of the covalent bonds absorb optical energy and escape to produce free electrons and electric hole carriers. The reverse current generated by the photodiode is increased with the absorbed optical energy to generate different output signals.

The light-emitting element 3 on the light-receiving element 2 can be light-emitting diode (LED). However, this is not limited.

Practically, the optical fiber 1 can be connected with a connector 12 which is correspondingly inserted in a first end of a housing 4. The light-receiving element 2 is firmly inlaid in or adhered to a second end of the housing 4. The light-emitting element 3 on the light-receiving element 2 is projectively axially aligned with the center of the end face 11 of the optical fiber 1, whereby the input light beam 10 of the optical fiber 1 can be directly projected to the light-receiving element 2 which converts the input light beam 10 into an electronic output signal to be output. After the light-emitting element 3 is energized, the light beam 30 generated by the light-emitting element 3 can be directly projected to the end face 11 of the optical fiber 1 and transmitted along the optical fiber 1 to the distal end. Accordingly, the object of duplex transmission can be achieved without mounting any reflective film or lens or refractive optical element ( ROE) between the optical fiber 1, the light-receiving element 2 and the light-emitting element 3.

In the duplex optical transmission-reception module of the present invention, it is unnecessary to mount any refractive element between the optical fiber 1, the light-receiving element 2 and the light-emitting element 3. Therefore, the structure of the present invention is simpler and easy to assemble. Also, the manufacturing cost of the present invention is lower than that of the conventional apparatus (about 1/30 of the cost of the conventional apparatus). Therefore, the quality of transmission satisfies the requirement of general users, while the cost is greatly reduced so that the present invention is more acceptable and competitive on market.

In the duplex optical transmission-reception module of the present invention, a focusing section 31 is connected on the top face of the light-emitting element 3. The light beam 30 emitted from the light-emitting element 3 is focused by the focusing section 31 to project the end face 11 of the optical fiber 1. Accordingly, the loss of the input light beam 10 of the optical fiber 1, which covers the light-emitting element 3 can be reduced to enhance the transmission speed of the present invention.

The duplex optical transmission-reception module of the present invention is applicable to video/audio signal transmission such as digital camera, network, etc. The application range is not limited.

The above embodiments are only used to illustrate the present invention, not intended to limit the scope thereof. Many modifications of the above embodiments can be made without departing from the spirit of the present invention.

1. A duplex optical transmission-reception module comprising:
(a) an optical fiber;
(b) a light-receiving element which corresponds to the optical fiber for receiving optical energy transmitted through the optical fiber from a distal end and converting the optical energy into electric energy which is output from an output terminal; and
(c) a light-emitting element connected on the light-receiving element, a center of the light-emitting element being projectively aligned with a center of the end face of the optical fiber, whereby when the light-emitting element is energized to project light beam outward, the light beam is projected right to the end face of the optical fiber and input to the optical fiber, the light beam being transmitted along the optical fiber to the distal end to be received by another receiver to output a signal, no refractive element being disposed between the optical fiber, the light-receiving element and the light-emitting element.

2. The duplex optical transmission-reception module as claimed in claim 1, wherein the light-receiving element is a photodiode.

3. The duplex optical transmission-reception module as claimed in claim 1, wherein the light-emitting element is a light-emitting diode.

4. The duplex optical transmission-reception module as claimed in claim 1, wherein the optical fiber is connected with a connector which is correspondingly inserted in a first end of a housing, the light-receiving element being firmly disposed at a second end of the housing.

5. The duplex optical transmission-reception module as claimed in claim 1, wherein a focusing section is connected on top face of the light-emitting element, the light beam emitted from the light-emitting element being focused by the focusing section to project the end face of the optical fiber.
